(19) United States
(12) Patent Application Publication
(10) Pub. No.: US 2024/0125580 A1
(43) Pub. Date: Apr. 18, 2024

(54) STAB PROOF MATERIAL IN ROLL FORM, METHOD AND PLANT FOR THE PRODUCTION THEREOF

(71) Applicant: SAATI S.P.A., Appiano Gentile (IT)

(72) Inventors: Franco MERLETTI, Appiano Gentile (IT); Thomas DELLA VEDOVA, Appiano Gentile (IT); Carmine LUCIGNANO, Appiano Gentile (IT); Paolo CANONICO, Appiano Gentile (IT)

(21) Appl. No.: 18/263,892

(22) PCT Filed: Mar. 8, 2022
(86) PCT No.: PCT/IB2022/052040

§ 371 Date: Aug. 2, 2023

(30) Foreign Application Priority Data
Mar. 10, 2021 (IT) 102021000005624

(51) Int. Cl. F41H 1/02; D06M 15/227; D06M 15/263; D06M 15/327; D06M 15/507; D06M 15/513; D06M 15/53; D06M 15/55; D06M 15/564; D06M 15/59; D06M 23/08

(52) U.S. Cl. CPC F41H 1/02; D06M 15/227; D06M 15/263; D06M 15/327; D06M 15/507; D06M 15/513; D06M 15/53; D06M 15/55; D06M 15/564; D06M 15/59; D06M 23/08; D06M 2101/36

(57) ABSTRACT

A stab proof material in roll form comprising a matrix distributed over both the surfaces of a textile structure and forming a surface film totally interpenetrated in said textile structure. The production method comprises the steps of: unwinding an aramid fabric on conveyor means; distributing an amorphous thermoplastic matrix starting from a micrometric powder, over both surfaces of the aramid fabric as it is unwound; passing the material through a first hot section and then through a second relatively cold section; the first section applies a temperature and a pressure such as to form an amorphous thermoplastic film on the fabric; the second section facilitates detachment of the coated material from the conveyor means. The plant comprises a conveyor belt on which an aramid fabric is unwound; a powder scattering station adapted to distribute a micrometric powder on the aramid fabric as it is unwound on the conveyor belt; a system of double belts in contact through which the fabric is conveyed; the system of double belts in contact defines a first hot section and a second relatively cold section; the first section applies a temperature and a pressure functional to the formation of an amorphous thermoplastic film on the fabric; the second section facilitates detachment of the fabric.

### BACKGROUND OF THE INVENTION

The present invention concerns a stab proof material in roll form and a method and plant for the production thereof.

More specifically, the present invention refers to a material used as a base for the production of articles provided with ballistic protection, in particular for the production of bullet-proof vests also having a given level of stab proof protection (against stab or spike).

The field of personal protection, as meant in this document, is characterized by the use of a wide range of materials, with the aim of responding especially to specific requirements in terms of ballistic performance and resistance to stabbing, but also to requirements commonly known and considered important according to market surveys, such as flexibility, optimization of manufacturing waste, etc.

A ballistic solution for “soft armoring”, as the functional part of a bullet-proof vest is called, is composed of many layers of different types of materials, each of which contributes totally or partially to one or more functions.

The list of materials used to compose a ballistic solution is very long and the combination of said materials is optimized especially thanks to a trial-and-error approach where the first test is defined on the basis of a starting database.

The products used include: aramid fabrics, polyethylene fabrics, aramid unidirectionals, polyethylene unidirectionals, aramid felts, metallic mesh, metallic plates, barriers with metallic or ceramic flakes, laminates made of resins/films on aramid or polyethylene fabrics, Multi Threat Penetration (MTP) sheets, i.e. sheet products provided with both ballistic and stab proof properties.

Alongside purely ballistic materials are types of products that can add a given level of stab proof protection to the vest, called stab proof products.

The stab proof materials analogous to the one described here are in general produced by means of a four-stage process:
lamination of a thermoplastic film or coating of a thermosetting resin on an aramid fabric in order to make it integral with said fabric;
cutting of the roll of bonded material into sheets of defined length;
layering of single sheets alternating with appropriately sized sheets of material with release coating;
insertion of the layered package into a static press and application of a pressing cycle with defined temperature, pressure and duration.

The resulting product is a finite number of semi-rigid flat sheets with ballistic and stab proof properties determined by various factors: choice of the fabric, matrix, percentage by weight of the latter with respect to the fabric, chemical composition and degree of interpenetration of the matrix with it.

Manufacture of the end product consists in cutting said sheets, and if necessary other materials to be used in combination, according to the shape of a bullet-proof vest, in accordance with the guidelines of the relevant reference standard, and making up the vest according to an arrangement of the layers designed to meet the relevant performance requirements.

The publication US 2016/0281272 A1 describes a composite material for ballistic applications, which comprises a bimodal binder.

### SUMMARY OF THE INVENTION

The aim of the present invention is to provide a production system of a fiber-reinforced and pre-impregnated composite material, a so-called pre-preg, which is innovative and alternative with respect to the conventional coating/lamination systems.

Within this aim, an object of the invention is to provide a system that makes available a product in roll form which enables all manufacturers, not equipped with infrastructures for shaping a large number of flat sheets, to work with MTP materials in the same way as they work with fabrics, unidirectionals, etc.

Another object of the invention is to provide a system that allows waste optimization, using the same templates, by making available a continuous roll instead stead of single pieces.

A further object of the present invention is to provide a high versatility in defining the configuration of the end product and a consequent significant reduction in costs.

These and further objects, which will become clearer below, are achieved by a stab proof material in roll form and a method and plant for the production thereof, as claimed in the appended claims.

### BRIEF DESCRIPTION OF THE DRAWINGS

Further characteristics and advantages of the subject of the present invention will become clearer from an examination of the description of a preferred but non-exclusive embodiment of the invention, illustrated by way of non-limiting example in the attached drawings, in which:

FIG. 1 is a schematic view illustrating an example of a plant for production of the material according to the invention;

FIG. 2 illustrates in perspective the composition of the laminate 10 obtained with the process of the invention.

### DETAILED DISCLOSURE OF PREFERRED EMBODIMENTS

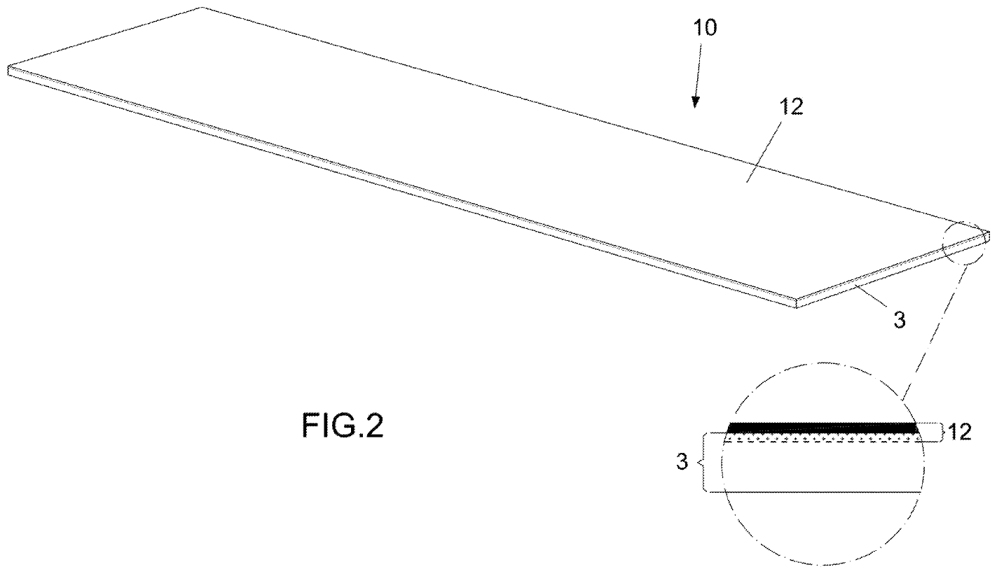

The laminate 10 is composed of a base fabric 3, on the surface of which the matrix 12 is deposited, formed of the micrometric powder 2 in a dry state; the latter is melted, compacted over the same fabric 3 and not only adheres to it but also interpenetrates it. In this case the object illustrated in FIG. 2 is shown as a product obtained with a process of deposition and pressure melting (that is a hot lamination under pressure) on both sides or both faces of the fabric.

In order to achieve this object, a further pressure melting stage is carried out also on the other face of the fabric, with analogous deposition of micrometric powder and pressure melting, to form an amorphous, i.e. non-crystalline, thermoplastic matrix, well interpenetrated inside the fabric.

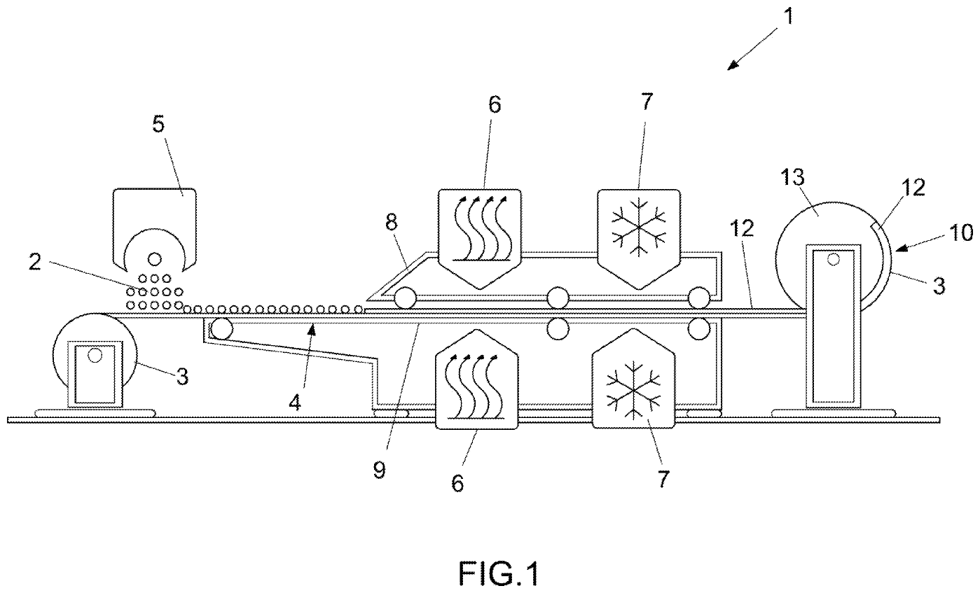

With particular reference to the numerical symbols of the above-mentioned figures, the composite material production method, according to the invention, is carried out by means of a plant schematically illustrated in FIG. 1 and indicated as a whole by the reference number 1.

According to the present invention, a starting amorphous thermoplastic matrix is obtained from the pressure melting treatment of a micrometric powder 2 which is distributed over the whole surface of both faces of a textile structure, in particular an aramid fabric 3 as it is unwound over a conveyor belt 4, by means of a powder scattering station 5.

This deposition is followed by entry of the material into the heart of the production line, formed of a system of double belts in contact, split into two sections, by means of which the material is conveyed along the line: a first hot section 6 and a second relatively cold section 7.

The first section 6 applies to the powder 2 a temperature ranging from 100 to 250° C. and a pressure from 0.1 N/cm² to 200 N/cm², preferably 160-250° C. and 10-200 N/cm², according to the chemical-physical characteristics of the powder used, functional to the formation of said surface amorphous thermoplastic matrix 12, which is then incorporated in the thickness of the fabric 3, by pressure melting of the powder 2 over the latter. The film or the matrix 12 totally interpenetrates the fibers of said fabric 3, thus forming a flexible pre-preg 10 wound in the form of a roll 13 (FIG. 1).

The second section 7 facilitates detachment of the material from the belts, by cooling to a temperature preferably below the melting or glass transition temperature of the film 12.

The double belt system comprises an upper belt 8 and a lower belt 9 and, according to the present invention, the thermoplastic matrix 12 is totally interpenetrated inside the fabric 3, with the desired basis weight obtained according to the speed of the line and the settings of the scattering head 5.

Inside the fabric 3 impregnated with thermoplastic resin, a phenomenon of fiber-interlocking occurs, which joins and compacts the weft and warp threads of the fabric 3, giving the composite improved resistance to cutting or stabbing.

According to the invention, the fabric 3 is a fabric for ballistic application made of para-aramid, glass, polyethylene (UHMWPE) or polypropylene fibers with denier from 220 to 3300 dtex.

The thermoplastic matrix 2 is obtained from a powder preferably based on polyesters, polyethers, polyolefins, polyvinyl butyral, polyurethanes, polyamides, polyimides and any derivatives or combinations thereof, having powder diameter distribution ranging from 0.1 to 750 μm.

The powder scattering system 5 associated with the double belt system, according to the invention, allows a choice totally free of constraints regarding the amount of powder 2 added to the support 3.

The present invention, in fact, allows the basis weight of the powder 2 to be adjusted from 20 to 250 g/m², in one single step.

The laminate 10 deriving from the present invention provides a flexible product in roll form which enables all the end manufacturers, not equipped with infrastructures for shaping flat sheets, to work with MTP materials in the same way as they work with fabrics, unidirectionals, etc. In fact, according to the invention, the laminate 10 is collected at the end of the production line in the form of a roll 13.

The stab proof product in roll form, obtained according to the present invention, has performance analogous to the conventional sheets, made from similar components, but thanks to the special architecture and to its nature, the product made according to the present invention can be used with a much lower number of layers.

This gives it a further significant economic advantage compared to the conventional products.

The following Table 1 shows a comparative example, relative to aramid fabrics with different matrixes, matrix weight percentage, from standard technology and the technology according to the invention.

TABLE 1
Comparison of performances of the innovative product in
roll form with a conventional high-performance sheet.

| | Area | Area | | | TDP@ |
|---|---|---|---|---|---|
| | density of | density of | Fiber | | 5.2 Kg/m² |
| | single layer | fabric | denier | # | KR1 E2 |
| Product | [g/m²] | (g/m²) | (dtex) | layers | [mm]* |
| Standard | 165 | 105 | 440 | 32 | 23 |
| sheet | | | | | |
| Laminate | 310 | 185 | 1100 | 17 | 22 |
| roll | | | | | |

*KR1 test according to the Home_Office_Body_Armour_Standard (2017), E2 = 36 J.

According to the present invention, stab proof products in roll form with analogous performances can be produced from the following components:
woven or non-woven fabrics composed of high tenacity and/or high modulus textile fibers typically used for ballistic applications or for the production of composites, such as aramid fiber, high density polyethylene (UHMWPE), polypropylene, polyamide, polyimide, polyester, polyarylester, PBO, S-glass, E-glass, carbon fiber; within the same chemical “family” the performance may vary depending on the brand used, even though the nominal characteristics remain the same;
among the textile fibers with particular reference to aramid and high density polyethylene fibers, deniers between 110 and 3300 dtex are identified; for each specific fabric there is an ideal amount of matrix to obtain stab proof performances, in turn linked to the chemical composition thereof and the way in which it interacts with each specific fiber;
the matrixes that can be used include thermoplastic or thermosetting resins having polymer-based chemical composition such as: polyethylenes, polyurethanes, polypropylene, polyamide, polyester, polyarylester, polyvinyl butyral, polycarbonate, phenolic, epoxy, phenoxy, polyurethane and acrylic resins;
the amount of matrix required in percentage with respect to the total weight of the laminate can vary from 10 to 50% by weight, and the ideal amount is closely correlated with the characteristics of the woven or non-woven fabric with which it is combined, for example with reference to Table 1 the 1100 dtex fabric used in the form of laminate 10 acquires optimal performance with the application of 40% of an appropriately selected matrix;
in the case of the woven fabric, in addition to the area weight and the denier of the component fiber/s, the number of threads per centimeter and the type of weave selected are important parameters. In particular, the following Table 2 shows different laminates that can be obtained in roll form and their performances as the mentioned parameters vary:

TABLE 2
Comparison of performances of different innovative products
in roll form with variation in their basic characterisics.

| | Area | | | | TDP@ |
|---|---|---|---|---|---|
| | density of | | Fiber | | 5.2 Kg/m² |
| | single layer | Matrix | denier | # | KR1 E2 |
| Product | [g/m²] | % | (dtex) | layers | [mm]* |
| Laminate 1 | 310 | 40 | 1100 | 17 | 22 |
| roll | | | | | |
| Laminate 2 | 300 | 35 | 930 | 18 | 24 |
| roll | | | | | |
| Laminate 3 | 250 | 36 | 670 | 21 | 25 |
| roll | | | | | |

*KR1 test according to the Home_Office_Body_Armour_Standard (2017), E2 = 36 J.

In practice it has been found that the invention achieves the intended aim and objects.

The laminate according to the present invention is obtained by means of a technology substantially different from a conventional coating/lamination and offers a number of substantial advantages.

The present invention provides a considerable versatility in definition of the product configuration. At least the following aspects should be considered.

The thermosetting resins used in ballistics, which are water- or solvent-based, are used in such a way as to determine a resin content to obtain optimized performances of the subsequently molded product.

The basis weight can be chosen on a continuous scale, however above given amounts (from 20 gsm to approximately 80 gsm) the control over the process in order to obtain uniform impregnation becomes very difficult in terms of controlling evaporation of the solvent or the water. Above the limit indicated, the formation of bubbles and the residual stickiness make the outgoing product unmanageable and unusable.

For this reason, whenever is possible, multiple impregnation steps are used, with consequent significant increase in costs.

On the other hand, the present invention allows adjustment of the basis weight from 20 up to 250 g/m² in one single step, requiring at the most an optimization of the process parameters (usually a simple temperature increase of a few degrees centigrade), since the absence of solvents results in the absence of problems connected with the formation of bubbles and with a high level of stickiness.

In the same way, coupling on two sides by means of a conventional system can be a difficult and expensive operation, whereas with the present invention the coupling on two sides can be carried out easily and with a limited increase in costs since the use of appropriate thermoplastic powders allows a choice of temperatures and pressures in section 6 which, during coating on the second side, do not alter what has already been deposited on the opposite side.

The conventional thermoplastic-based systems are made from films with specific basis weight (most commonly 50-100 g/m², sometimes 25-75-125 g/m²), a limiting factor with regard to the choice of the matrix content which often does not allow simultaneous adoption of the best fabric and choice of the optimal resin content to meet a required performance.

With the process of the present invention this limitation is overcome, since basis weights from 20 to 250 g/m² can be chosen without gaps on a continuous basis.

1. A process for the production of a stab proof flexible material in roll form, characterized in that it comprises the steps of:
unwinding a textile structure (3) on conveyor means;
dry distributing an adhesive consisting of a micrometric powder (2) of thermoplastic material on both faces or both surfaces of said textile structure (3);
heating to the melting temperature and compressing said powder (2) on said surfaces of the textile structure (3) so as to form on them an amorphous thermoplastic matrix (12) completely interpenetrated inside said textile structure (3) as it is unwound;
cooling the composite material (10) thus obtained, to facilitate detachment of the latter from said conveyor means.

2. The process according to claim 1, characterized in that said powder (2) is heated to a temperature from 160 to 250° C. and is subsequently compressed at a pressure ranging from 0.1 N/cm² to 200 N/cm².

3. The process according to claim 1, characterized in that said cooling of the composite material (10) is carried out below the melting or glass transition temperature of said thermoplastic matrix (12).

4. A stab proof material in roll form obtained with the process according to claim 1, characterized in that it comprises an amorphous thermoplastic matrix (12) distributed over the whole surface of said textile structure (3) and forming a surface film totally interpenetrated inside said textile structure.

5. The material according to claim 4, characterized in that said textile structure (3) consists of a woven or non-woven fabric composed of elements selected from textile fibers, aramid fibers and high density polyethylene fibers.

6. The material according to claim 4, characterized in that said textile structure (3) consists of a woven or non-woven fabric composed of elements selected from high tenacity and/or high modulus textile fibers, composites such as aramid fiber, high density polyethylene (UHMWPE), polypropylene, polyamide, polyimide, polyester, polyarylester, PBO, S-glass, E-glass, carbon fiber.

7. The material according to claim 4, characterized in that said matrix (12) is selected from thermoplastic or thermosetting resins having chemical composition based on polymers such as: polyethylenes, polyurethanes, polypropylene, polyamide, polyester, polyarylester, polyvinyl butyral, polycarbonate, phenolic, epoxy, phenoxy, polyurethane and acrylic resins.

8. The material according to claim 4, characterized in that said matrix (12) is present from 10% by weight to 50% by weight based on the total weight of said material.

9. A plant for the production of a stab proof material in roll form, characterized in that it comprises a conveyor belt (4) on which a textile structure (3) is unwound; a powder scattering station (5) adapted to distribute a micrometric powder (2) on both faces of said textile structure (3) as it is unwound on said conveyor belt (4); a system of double belts in contact (8,9), split into two sections, through which said textile structure (3) is conveyed; said system of double belts in contact defining a first hot section (6) and a second relatively cold section (7); said first section (6) applying a temperature and a pressure functional to the formation of said thermoplastic matrix on both faces of said textile structure; said second section (7) facilitating detachment of said textile structure.

10. The plant according to claim 9, characterized in that said double belt system comprises an upper belt (8) and a lower belt (9) acting on said textile structure (3) and said thermoplastic matrix (12), providing complete interpenetration of said matrix inside said textile structure.
